(19) United States
(12) Patent Application Publication
(10) Pub. No.: US 2025/0026279 A1
(43) Pub. Date: Jan. 23, 2025

(54) JACK-MOUNTED STORAGE CARRIER

(71) Applicants: Marcus Niemela, Houghton, MI (US); Chase P. Sturos, Laurium, MI (US)

(72) Inventors: Marcus Niemela, Houghton, MI (US); Chase P. Sturos, Laurium, MI (US)

(21) Appl. No.: 18/776,632

(22) Filed: Jul. 18, 2024

Related U.S. Application Data
(60) Provisional application No. 63/514,269, filed on Jul. 18, 2023.

(51) Int. Cl. B60R 9/06

(52) U.S. Cl. CPC B60R 9/06

(57) ABSTRACT

A jack-mounted storage carrier allows a user to utilize the mechanical advantage of a manual camper jack, or a powered camper jack, to conveniently lift, lower, and stow a storage carrier and associated article(s) along the exterior of a vehicle or camper. The storage carrier is pivotable relative to the camper jack, and is vertically movable by the extendable post of the camper jack, so that the camper jack supports the storage carrier and allows or facilitates its movement between stowed and deployed positions. In the deployed position the stored article(s) may be rested proximate or along a ground surface that is also contacted by a foot of the camper jack, and in the stowed position the stored article(s) may be rested on a step or other support associated with the camper or vehicle.

### CROSS REFERENCE TO RELATED APPLICATION

The present application claims the benefit of U.S. patent application, Ser. No. 63/514,269, filed Jul. 18, 2023, which is hereby incorporated herein by reference in its entirety.

### FIELD

The present invention relates to storage devices for vehicles and campers.

### BACKGROUND

Storage spaces are often at a premium for vehicles and campers, with designers and manufacturers seeking to provide as much usable storage space as practical without excessive detrimental impact on the vehicle's or camper's usability, convenience, and even aerodynamics. For some items like spare tires, bicycles, kayaks, and some storage boxes, it is often preferable to store or carry them along the exterior of a vehicle or camper because they are heavy, bulky, or they are (or contain) items that are generally only used outside the vehicle or camper. Campers, in particular truck campers (campers that are mounted in the beds of pickup trucks), are sometimes equipped with camper jacks that have a long telescoping post fitted with a ground-contacting foot, for stabilizing and leveling the truck camper, and even for lifting the truck camper from the truck bed so that the truck may be conveniently separated from the truck camper without the use of external lifts.

### SUMMARY

The present invention provides a jack-mounted storage carrier that allows a user to utilize the mechanical advantage of a manual or powered camper jack to conveniently lift, lower, and store items at a storage carrier along the exterior of a vehicle or camper. The storage carrier is vertically raisable and lowerable with an extendable post of the camper jack, and may be is pivotable relative to the camper jack. The storage carrier thus allows the camper jack to support the storage carrier and allow or facilitate its movement between stowed and deployed positions. In the deployed position the stored item(s) may be rested along a ground surface that is also contacted by a bottom pad or foot of the camper jack, and in the stowed position the stored item(s) may be rested on a step associated with the camper or vehicle. The jack-mounted storage carrier of the present invention may be compatible for use with the vehicle mounted accessories, access platforms, and storage components disclosed in commonly-owned U.S. Pat. No. 11,840,197, titled “VEHICLE MOUNTED ACCESSORY,” and in commonly-owned U.S. patent application Ser. No. 18/050,208, filed Oct. 27, 2022, U.S. Pub. No. 2023/0132547, the disclosures of which are hereby incorporated herein by reference in their entireties.

In one form of the present invention, a storage carrier is provided for coupling to a camper jack or similar telescoping shaft arrangement, and for using the camper jack to raise and lower articles for storage or use as desired. The storage carrier includes upper and lower arms, and an article support coupled to one or both arms. The upper arm has a proximal end portion capable of rotatably coupling at an upper post of a camper jack, and further capable of sliding along a longitudinal axis of the camper jack. The lower arm is coupled to the upper arm and has a proximal end portion for rotatably coupling to an extendable lower post of the camper jack. The connection of the lower arm to the extendable lower post of the camper jack allows it to be raised and lowered by the camper jack. The upper and lower arms are raisable and lowerable together with the extendable lower post of the camper jack, and are pivotable between a stowed position and a deployed position.

Therefore, the storage carriers of the present invention allow an operator to utilize one or more camper jacks for lifting and stowing, deploying and lowering, one or more articles such as a spare tire, bicycles, kayaks, coolers, a generator, a storage box, or substantially any other desired articles that may be useful to the operator while using a truck camper or similar vehicle or structure. The camper jack is normally only used for supporting a truck camper along a ground surface while not being carried by a pickup truck, and is therefore available for other uses while the truck camper is mounted at the pickup truck. Of course, it is also possible to mount a camper jack or similar telescoping shaft structure to other vehicles, trailers, watercraft, or the like, so that the jack can be utilized in conjunction with a storage carrier and provide the benefits thereof for other vehicles.

These and other objects, advantages, purposes and features of this invention will become apparent upon review of the following specification in conjunction with the drawings.

### BRIEF DESCRIPTION OF THE DRAWINGS

FIG. 1 is a rear elevation view of the left side of a truck camper fitted with a camper jack and storage carrier, with the camper jack and storage carrier shown in the stowed configuration;

FIG. 2 is a top plan view of the back-left corner of the truck camper, camper jack, and storage carrier of FIG. 1, shown in the stowed configuration (solid lines) and in a deployed or partially-deployed configuration (broken lines); and

FIG. 3 is a left elevation view of the back-left corner of the truck camper, camper jack, and storage carrier of FIG. 1, shown with the storage carrier and camper jack in a deployed configuration, with an extendable post of the camper jack and also the storage carrier and a spare tire shown in broken lines;

FIG. 4 is a left-rear perspective view of a truck camper resting on a flat bed and shown fitted with a camper jack and storage carrier in accordance with the present invention, with the storage carrier shown in the stowed configuration;

FIGS. 5A and 5B are enlarged left-rear perspective views of the truck camper and storage carrier of FIG. 4, in which a tire and tie-down straps are omitted from FIG. 5B to show other structures;

FIGS. 6A and 6B are left-rear perspective views of the truck camper and storage carrier of FIG. 4, with the storage carrier move to a partially-deployed configuration that is pivoted about 45 degrees from the stowed configuration, and with the tire and tie-down straps omitted from FIG. 5B to show other structures;

FIGS. 7A and 7B are left-rear perspective views of the truck camper and storage carrier of FIG. 4, with the storage carrier move to a partially-deployed configuration that is pivoted about 90 degrees from the stowed configuration, and with the tire and tie-down straps are omitted from FIG. 7B to show other structures;

FIGS. 8A and 8B are left-rear perspective views of the truck camper and storage carrier of FIG. 4, with the storage carrier move to a partially-deployed configuration that is pivoted about 180 degrees from the stowed configuration, and with the tire and tie-down straps omitted from FIG. 8B to show other structures;

FIGS. 9A and 9B are left-rear perspective views of the truck camper and storage carrier of FIG. 4, with the storage carrier moved to a fully-deployed configuration by lowering the carrier, and with the tire and tie-down straps omitted from FIG. 9B to show other structures;

FIG. 10 is a partially-exploded rear perspective view of the storage carrier in the 180-degree partially-deployed configuration;

FIG. 11 is a rear elevation view of the truck camper and storage carrier of FIGS. 4 and 5A;

FIG. 12 is a top perspective view of the truck camper and storage carrier of FIG. 11;

FIG. 13 is an enlarged view of the area designated ‘XIII’ in FIG. 12;

FIG. 14 is an enlarged left-rear perspective view of the truck camper and storage carrier of FIG. 9A;

FIG. 15 is an enlarged view of the area designated ‘XV’ in FIG. 14;

FIG. 16 is an enlarged view of the lower region of the storage carrier pivot mechanism, shown when the carrier is raised and in the 90-degree pivoted orientation of FIGS. 7A and 7B;

FIG. 17 is an enlarged view of the area designated ‘XVII’ in FIG. 15, showing the lower region of the storage carrier pivot mechanism when the carrier is lowered and in the 180-degree pivoted orientation of FIGS. 9A and 9B;

FIG. 18 is an enlarged view of the area designated ‘XVIII’ in FIG. 4, showing the upper region of the storage carrier pivot mechanism when the carrier is raised and in the stowed configuration of FIG. 4;

FIG. 19 is a top plan view of the storage carrier in the partially-deployed configuration that is pivoted about 45 degrees from the stowed configuration;

FIG. 20 is a top plan view of the storage carrier in the stowed configuration;

FIG. 21 is a top-rear-left perspective view of a carriage portion of the storage carrier of FIG. 4, shown with tire and straps omitted;

FIG. 22 is a rear-left perspective view of the carriage portion of FIG. 21, shown with tire and straps installed;

FIG. 23 is a front-right perspective view of the carriage portion of FIG. 22; and

FIG. 24 is a rear-right perspective view of another carriage portion with a loading and deployment ramp in a raised position.

### DESCRIPTION OF THE PREFERRED EMBODIMENTS

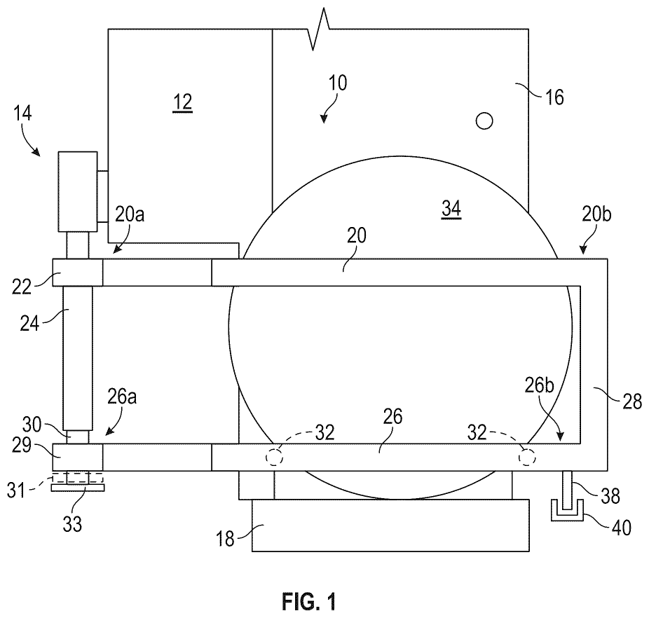

Referring now to the drawings and the illustrative embodiments depicted therein, a jack-mounted storage carrier 10 allows for convenient lifting, lowering, and storage of articles along an exterior of a vehicle, such as a pickup truck, or a camper, such as a truck camper 12 (FIG. 1). It will be understood that truck camper 12 is representative of substantially any vehicle or trailer, such as a camper trailer, pickup truck, recreational vehicle (“RV”), camper trailer, boat, or the like. Storage carrier 10 is mountable to a camper jack 14, and is raisable and lowerable using a raising and lowering mechanism of the camper jack 14, so that the mechanical advantage of the camper jack may be utilized by an operator. Camper jacks 14 are typically electrically powered and actuated by an onboard switch and/or a wired or wireless remote control, or are manually operable via a hand crank. The storage carrier 10 may be pivotable relative to the camper jack 14 so that the storage carrier 10 can swing away from the truck camper 12 and thus allow users to have simultaneous access to truck camper 12 and to items stored at or in the storage carrier 10. When stowed, storage carrier 10 may be positioned alongside an access door 16 of the truck camper 12, and above a step 18 of the truck camper 12, such as shown in FIG. 1. As will be explained in more detail below, storage carrier 10 relies upon camper jack 14 to raise and lower storage carrier 10 and any article(s) it supports. It should be appreciated that camper jack 14 is representative of substantially any telescoping shaft arrangement having one shaft portion that is extendable and retractable relative to another shaft portion.

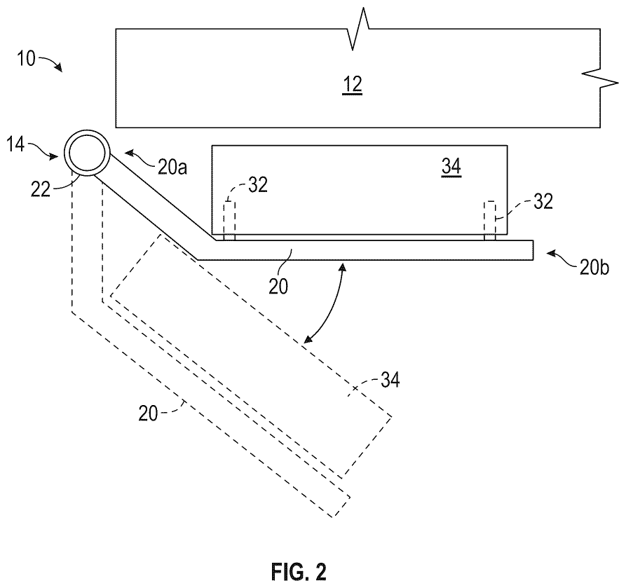

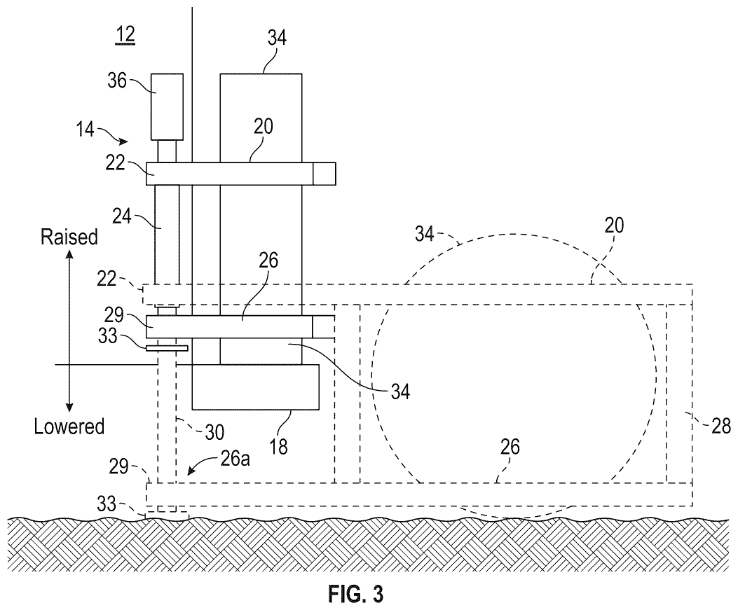

Storage carrier 10 includes an upper lateral arm 20 having a proximal end portion 20a fitted with an upper slip collar 22 that is rotatably coupled to an upper post 24 of the camper jack 14. Slip collar 22 is rotatable about a longitudinal axis of upper post 24, and is also slidable along the upper post 24 in the longitudinal direction. Storage carrier 10 further includes a lower lateral arm 26 coupled to the upper lateral arm 20 at their respective distal end portions 20b, 26b via an upright bar 28. The lower lateral arm 26 has a proximal end portion 26a fitted with a lower collar 29 that is rotatably coupled to an extendable lower post 30 of the camper jack 14. Lower collar 29 does not translate longitudinally along the lower post 30 of the camper jack 14, but instead maintains a fixed vertical spacing with upper slip collar 22 as the lower post 30 is extended downwardly and retracted upwardly relative to the camper jack's upper post 24. Optionally, a retention collar 31 (FIG. 1) is coupled to the extendable lower post 30, below the proximal end portion 26a of the lower lateral arm 26, and above a resting pad or foot plate 33 of the camper jack 14. Thus, the upper and lower lateral arms 20, 26 are raisable and lowerable together with the extendable lower post 30 of the camper jack 14, and are also pivotable about a longitudinal axis of the camper jack 14 between a stowed position (solid lines in FIGS. 2 and 3) and a deployed position (broken lines in FIGS. 2 and 3).

Article supports 32 may be simple posts or brackets (FIGS. 1 and 2) along one or both lateral arms 20, 26 for supporting an article 34 such as a spare tire (shown), or may take different configurations such as a cradle, bracket, storage box, bicycle rack, kayak rack, flexible straps, or the like. Article supports 32 retain the article 34 relative to the lateral arms 20, 26 until the article is released by a user. Therefore, the article 34 swings about the longitudinal axis (FIG. 2) as the storage carrier 10 is moved between stowed and deployed positions.

Referring to FIG. 3, article 34 may rest atop the step 18 when in the stowed position, so that step 18 may bear all (or a substantial portion of) of the weight load of article 34 and storage carrier 10 combined. This also prevents high moment (torque) loads from being applied to camper jack 14 by the upper collar 22 and lower collar 29, particularly when the truck camper 12 is being hauled over uneven terrain. Transferring the weight of article 34 and storage carrier 10 to the step 18 is accomplished by raising a bottom portion of article 34 above step 18 when raising the lower post 30, swinging the article 34 over the step 18, and then lowering the lower post 30 a sufficient distance so that article 34 rests atop the step 18 and substantially or entirely unloads the camper jack 14. Article 34 may be rested along the ground surface when in the deployed position, so that elevated moment (torque) loads are not applied to camper jack 14 except when in transit between the stowed (solid line) and deployed (broken line) positions. A pin 38 and catch 40 (FIG. 1) may be used to help secure storage carrier 10 in the stowed position, so as not to rely on only frictional engagement of article 34 with step 18 to maintain storage carrier 10 in the stowed position.

Optionally, camper jack 14 includes an electric motor 36 that is operable to downwardly extend and upwardly retract the lower post 30 relative to the upper pose 24. The camper jack may further include a controller that is in wireless communication with a hand-held remote controller carried by a user. However, it is envisioned that a manually operated camper jack, which may be fitted with a hand-crank, for example, may also be used to raise and lower the article 34 and storage carrier 10 in substantially the same manner as described above. It is further envisioned that the camper jack's extendable and retractable post 30 may be used to raise and lower the storage carrier 10 as long as the upper post 24 is supported by another structure (e.g., a camper or vehicle) in an elevated location.

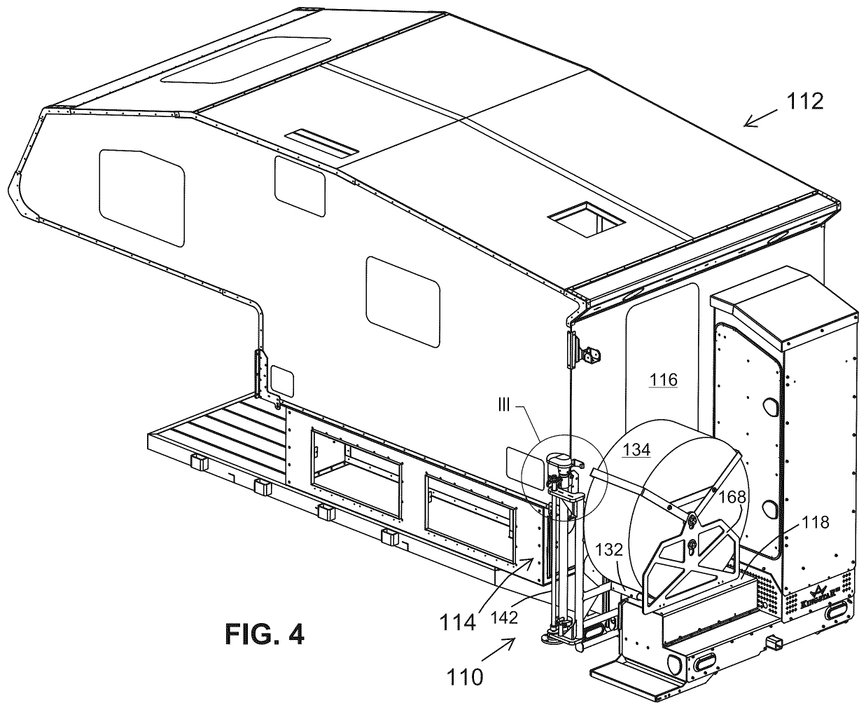

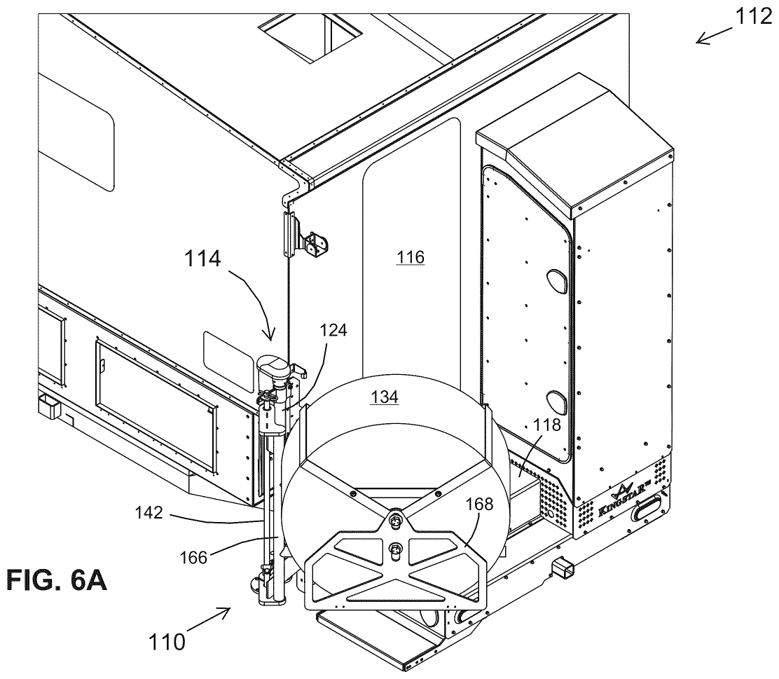

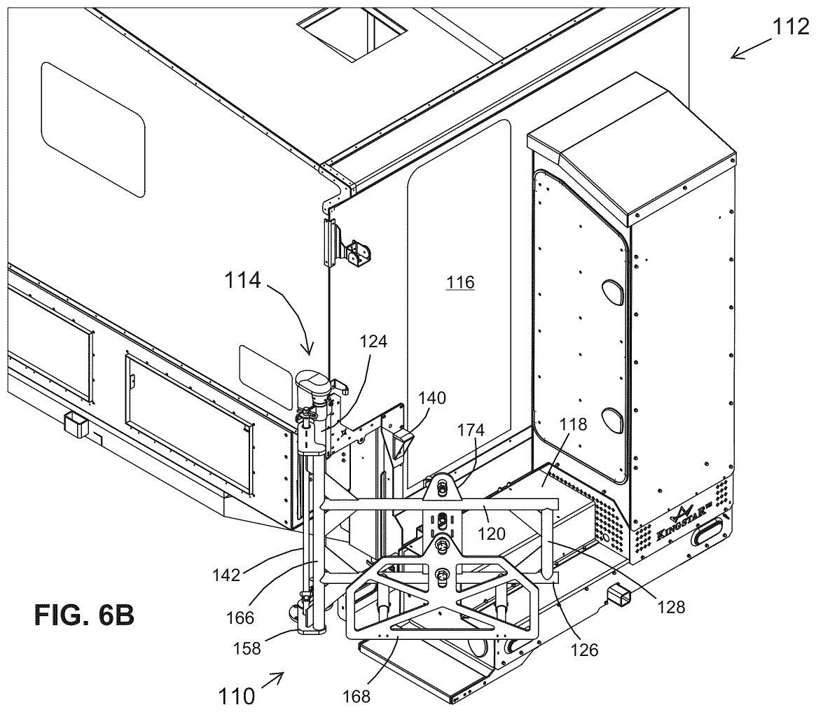

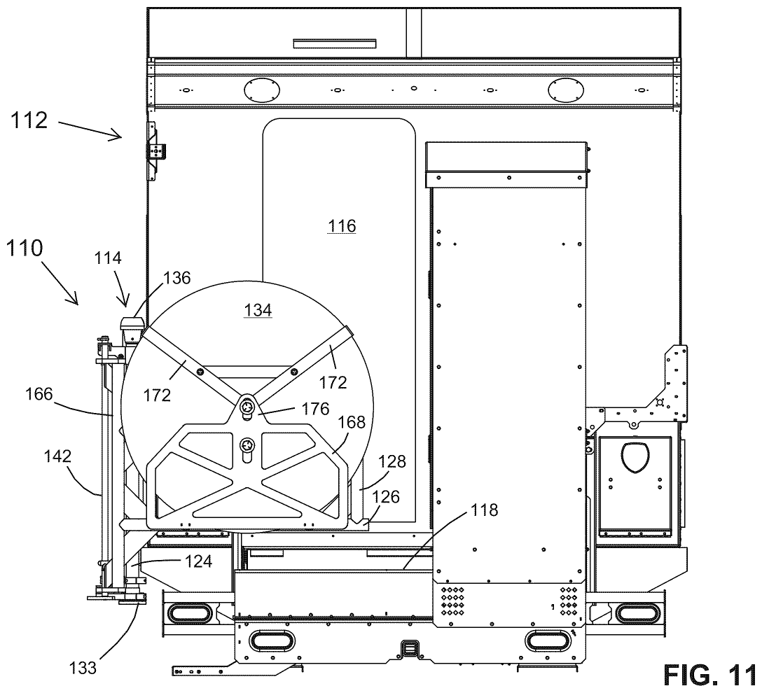

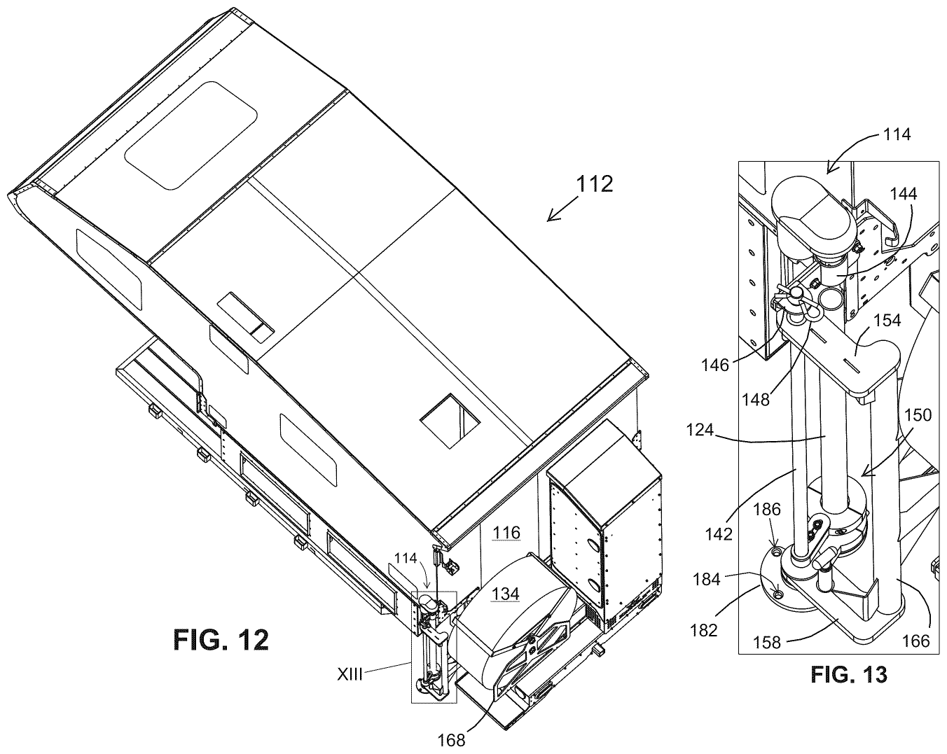

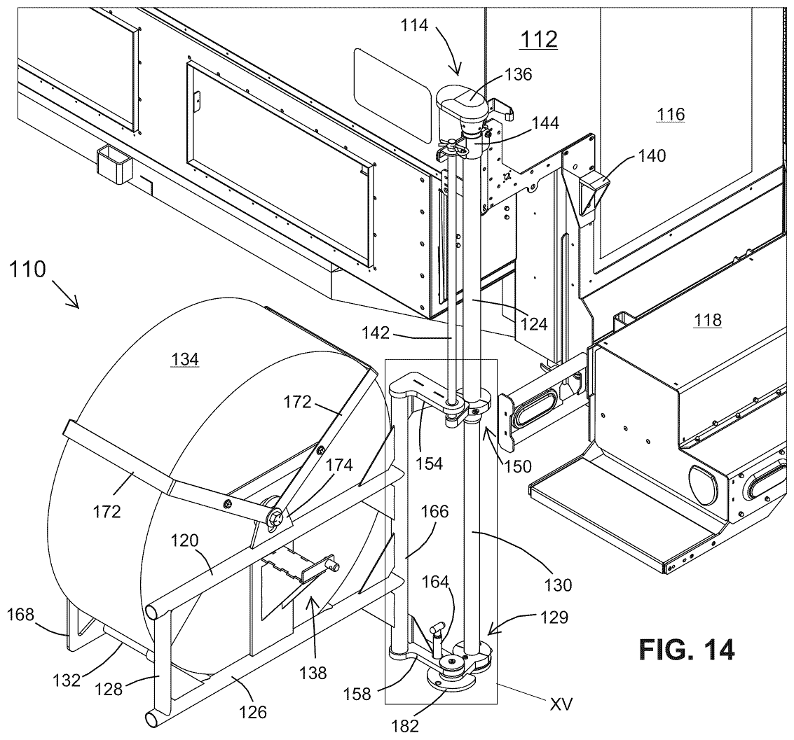

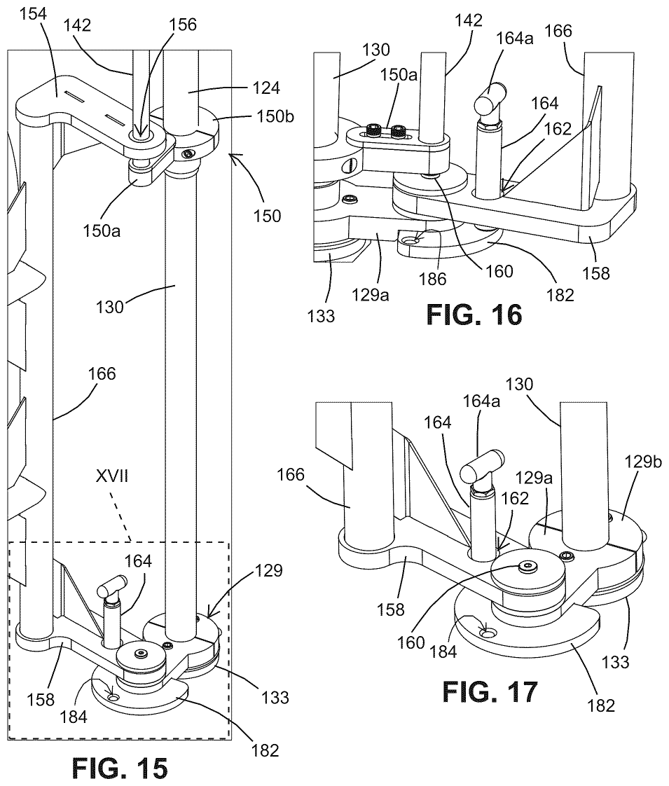

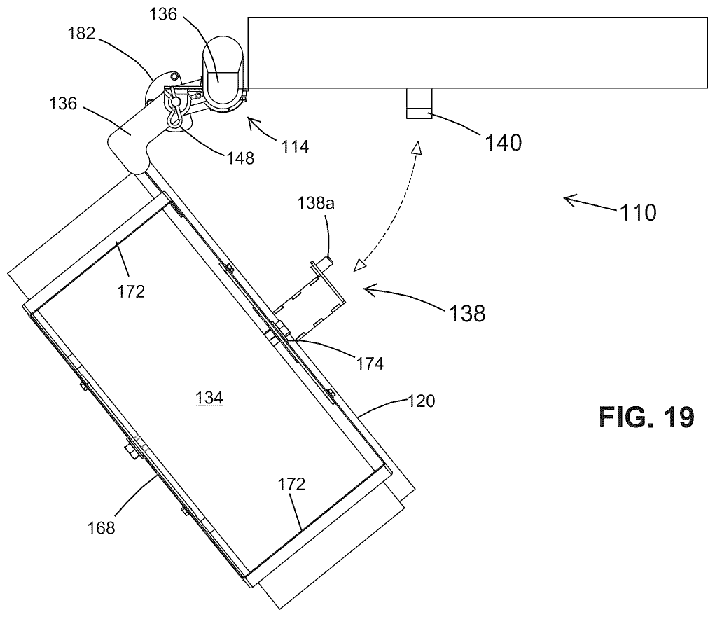

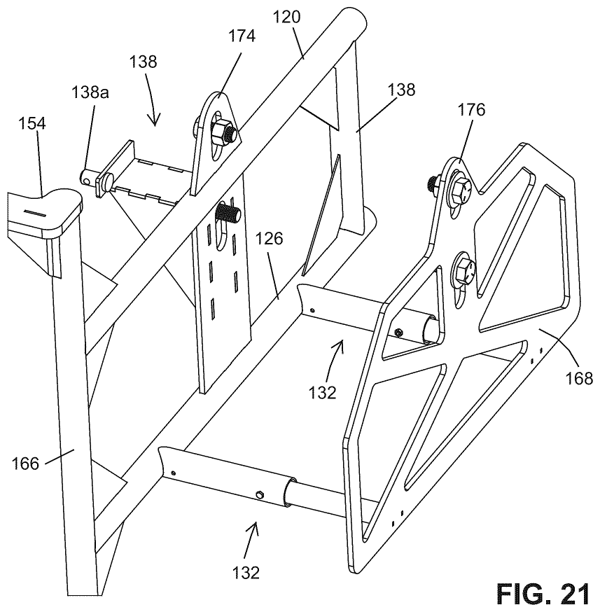

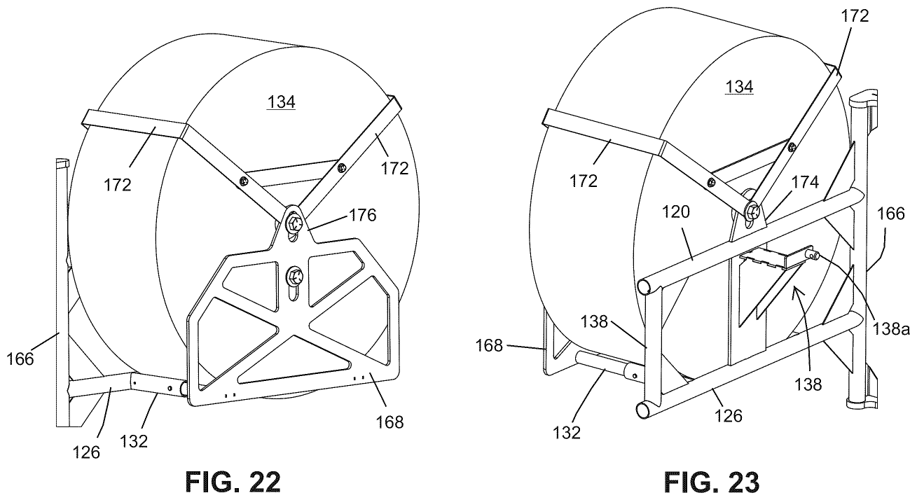

Referring now to FIGS. 4-14, another storage carrier 110 is shown coupled to a camper jack 114 at the back-left corner of a truck camper 112. Storage carrier 110 is similar in many respects to the storage carrier 10 described above with respect to FIGS. 1-3, with corresponding components given like reference numerals with the addition of 100 to facilitate understanding, such as upper lateral arm 120 and lower lateral arm 126 of storage carrier 110 corresponding to lower lateral arm 20 and upper lateral arm 26 of storage carrier 10. In this manner, most structures of storage carrier 110 may be understood with reference to the above descriptions of storage carrier 10, and the follow description will focus primarily on distinctions of the storage carrier 10 of FIGS. 4-14 as well as its sub-components illustrated in FIGS. 15-24.

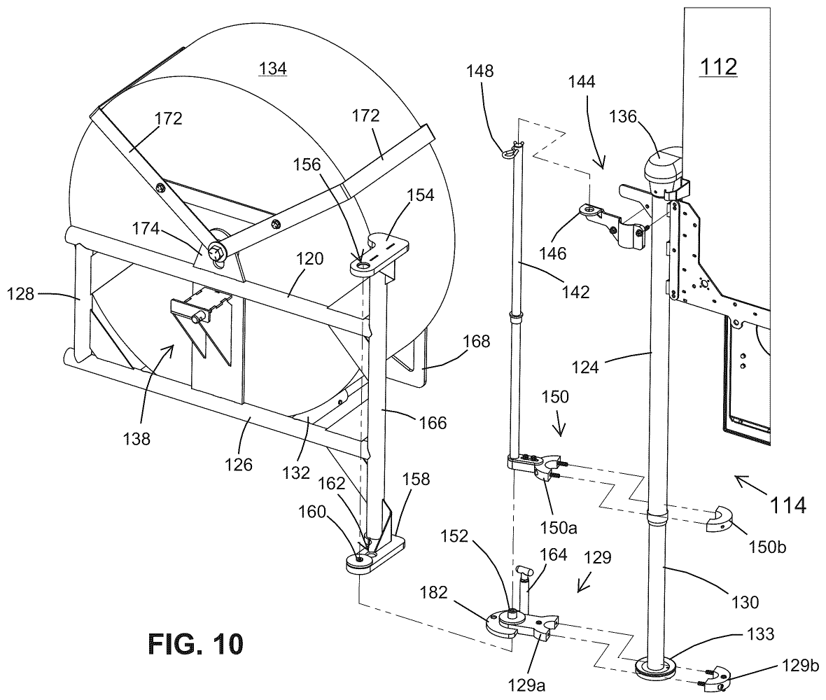

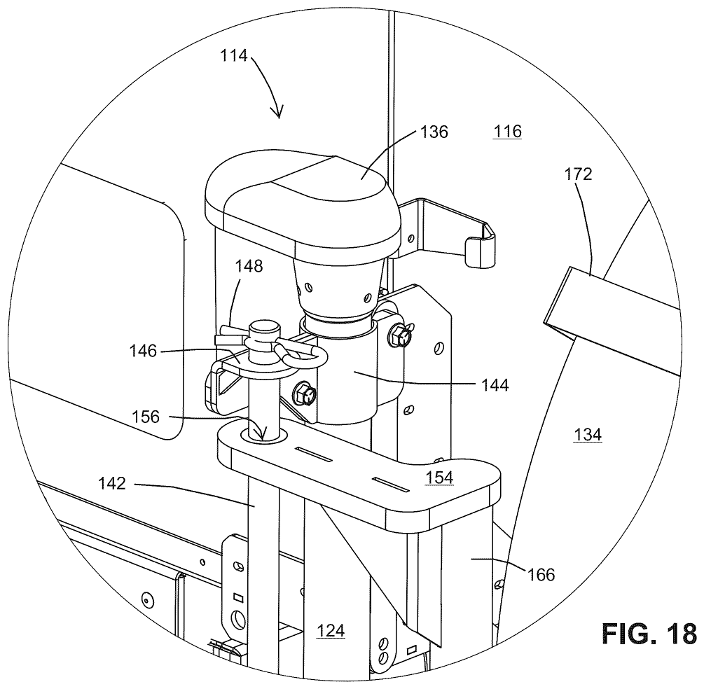

Storage carrier 110 is attachable to the same or substantially the same camper jack 114 as storage carrier 10, but utilizes a support rod 142 that is mounted to upper post 124 of camper jack 114 in a parallel and spaced-apart arrangement. As best shown in FIG. 18, an upper end portion of support rod 142 is coupled to upper post 124 via an upper bracket 144 having a proximal end portion that clamps to the upper post 124 using fasteners, and a distal end portion with a mounting tab 146 that receives an upper end of the support rod 142, the support rod 142 being secured with a cotter pin 148 that passes through a bore in support rod 142 above the mounting tab 146. A lower end portion of support rod 142 is coupled to upper post 124 via a two-piece central collar 150 including a rod-engaging portion 150a and a post-engaging portion 150b, which portions each define a half-circular recess for receiving a respective portion of upper post 124 at its lower region (FIG. 10). The portions 150a, 150b of central collar 150 couple together via fasteners as shown in FIG. 10 so that support rod 142 is separable from upper post 124 by removing the respective fasteners of central collar 150 and upper bracket 144. A lower collar 129 is constructed similarly to central collar 150, including a carriage bracket-engaging portion 129a and a lower post-engaging portion 129b that are secured around the extendable lower post 130, above the resting pad or foot plate 133, so that lower collar 129 travels up and down with extendable lower post 130 as it is extended (down) and retracted (up) in a telescoping manner relative to upper post 124. A lower end of support rod 142 is received in the rod-engaging portion 150a of central collar 150, which also receives an upwardly-extending post 152 at the carriage bracket-engaging portion 129a of the lower collar 129, such as shown in FIG. 10.

Support rod 142 allows for fixed couplings to the camper jack's upper post 124, at upper bracket 146 and central collar 150, so that there is little or no sliding or rotating contact with upper post 124 of camper jack 114. An upper carriage bracket 154 has a bore 156 that receives support rod 142 to allow the bracket 154 to slide up and down along support rod 142, and to also rotate or pivot along support rod 142. A lower carriage bracket 158 is shaped similarly to upper carriage bracket 154 and has a short post 160 that maintains coaxial alignment with support rod 142 and upwardly-extending post 152, such as shown in FIGS. 10 and 16. Lower carriage bracket 158 further defines a pin bore 162 for receiving a lock pin 164 with release handle 164a, which is operable to selectively secure the carriage against rotation, as will be described below in more detail.

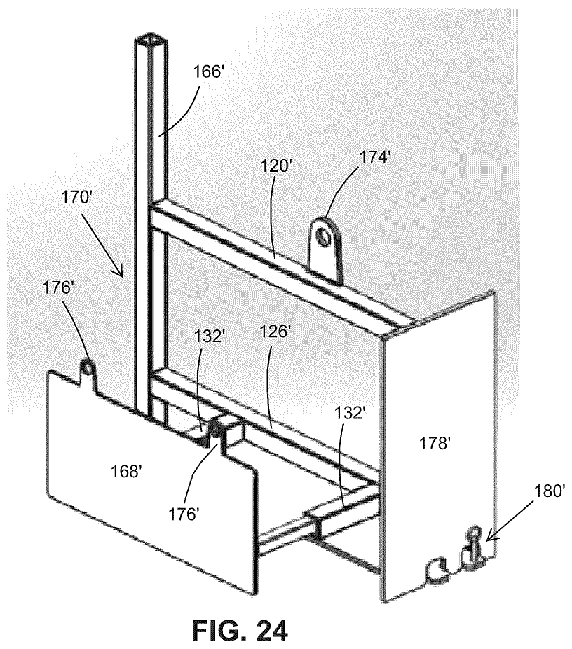

An upright bar or carriage post 166 extends between upper carriage bracket 154 and lower carriage bracket 158, and is rigidly coupled to the brackets 154, 158. Upright carriage post 166 is thus pivotable about a pivot axis defined through bore 156, short post 160, upwardly-extending post 152, support rod 142, and mounting tab 146. Upper lateral arm 120 and lower lateral arm 126 extend laterally or horizontally away from upright carriage post 166, and are further coupled together at their distal end portions by an upright bar 128. A pair of telescoping article supports 132 extend laterally or horizontally outwardly from lower lateral arm 126, and terminate at an upright article support bracket or panel 168 to define a width-adjustable article-receiving space 170 for an article such as a tire 134 that rests upon the article supports 132. In the illustrated embodiment, a pair of flexible securing members such as bands or straps 172, couple to a tab 174 that extends upwardly from the upper lateral arm 120, extend over the tire 134, and couple to another tab 176 that extends upwardly from the upright article support panel 168. Straps 172 may be released from one or both tabs 174, 176 to permit the tire 134 to be removed from the carriage that is formed by brackets 154, 158, upright carriage post 166, lateral arms 120, 126, article supports 132, and support panel 168. Optionally, and as shown in FIG. 24, another carriage that generally corresponds to that of FIGS. 4-23, in which reference numerals 120′, 126′, 132′, 166′, 168′, 170′ 174′, and 176′ correspond to the structures corresponding to reference numerals 120, 126, 132, 166, 168, 170, 174, and 176, a loading and unloading ramp 178′ may be coupled to one of the telescoping article supports 132′ and selectively retained in an upright orientation (shown) by a securing pin 180′. The ramp 178′ may be deployed by removing the pin 180′ and pivoting the ramp 178′ down so that its distal edge is lowered into contact with a ground surface, allowing a tire 134 or other article to be more easily rolled into or out of the width-adjustable article-receiving space 170′. When the ramp 178′ is raised as shown it encloses a side region of the receiving space 170′.

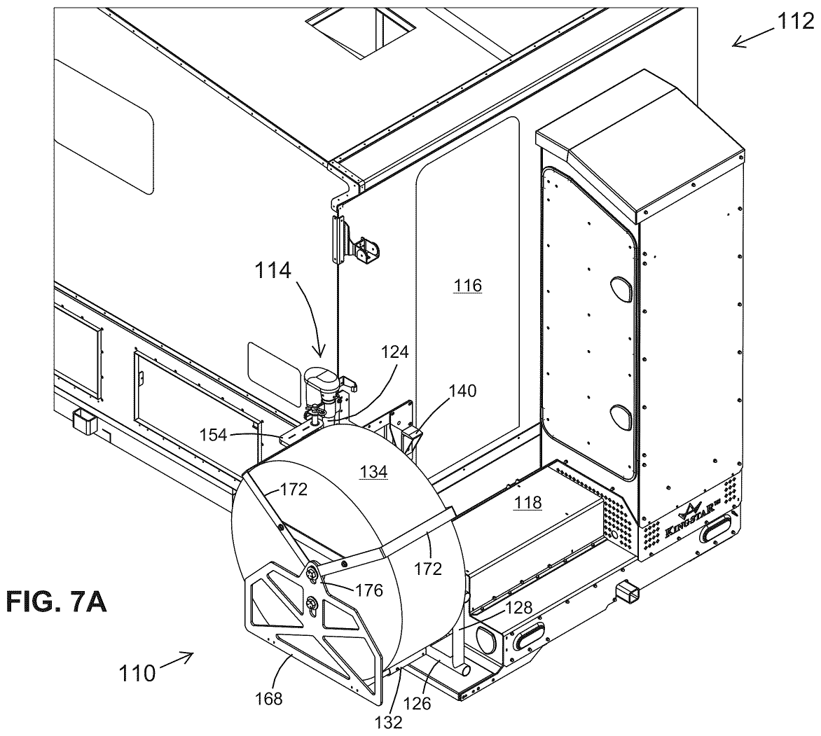

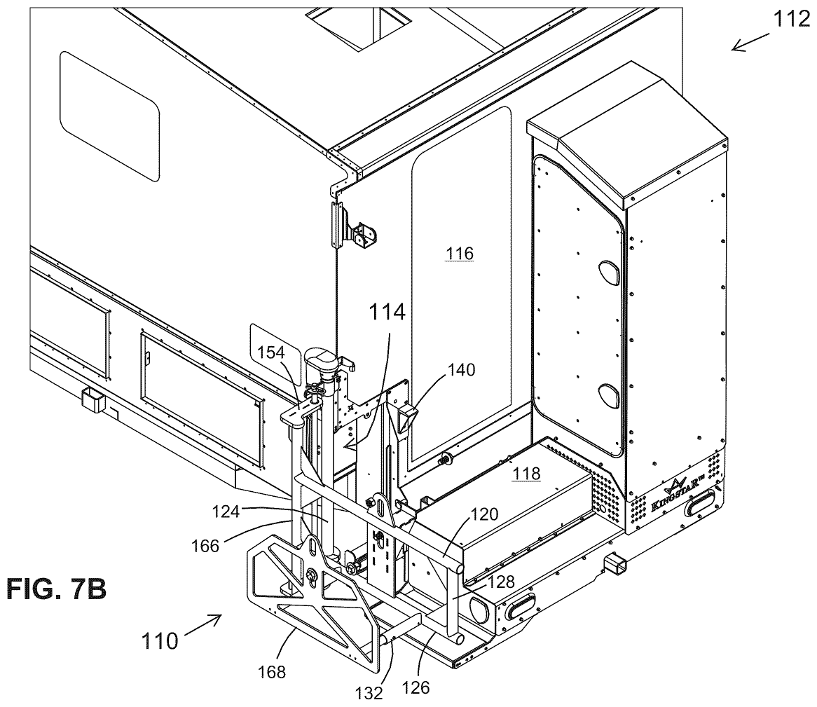

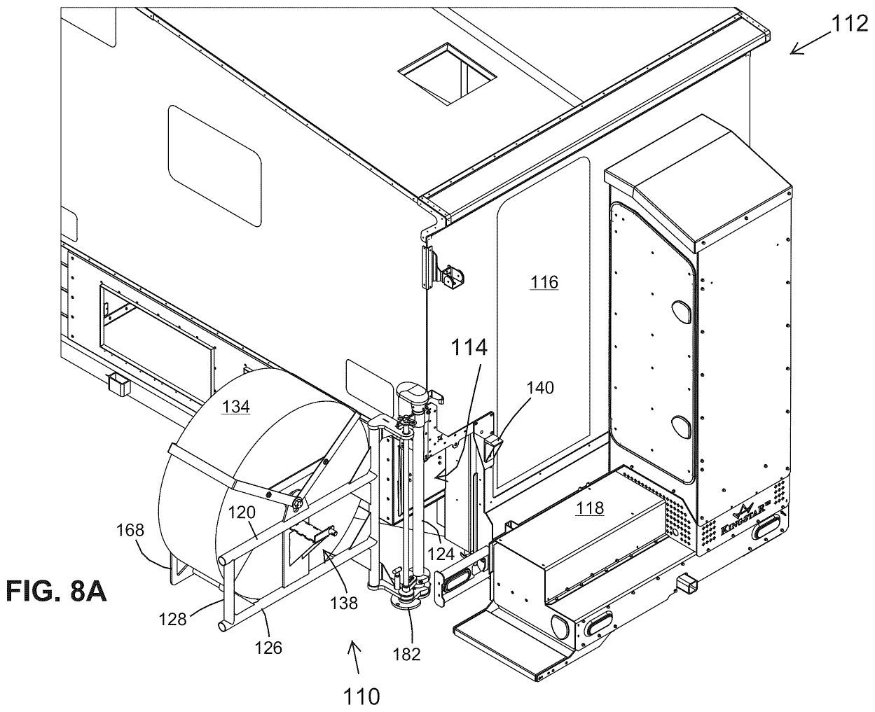

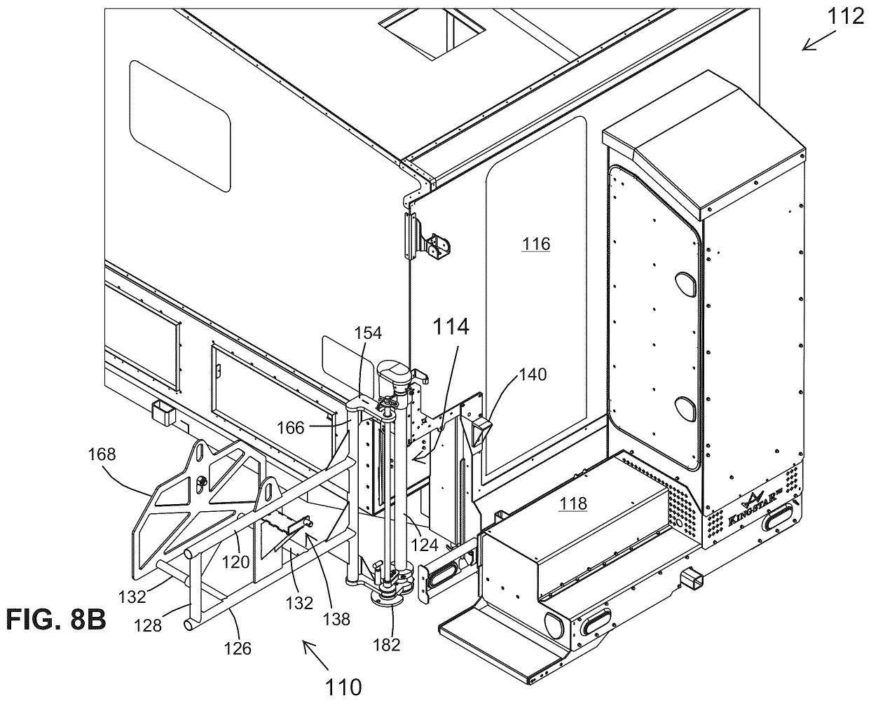

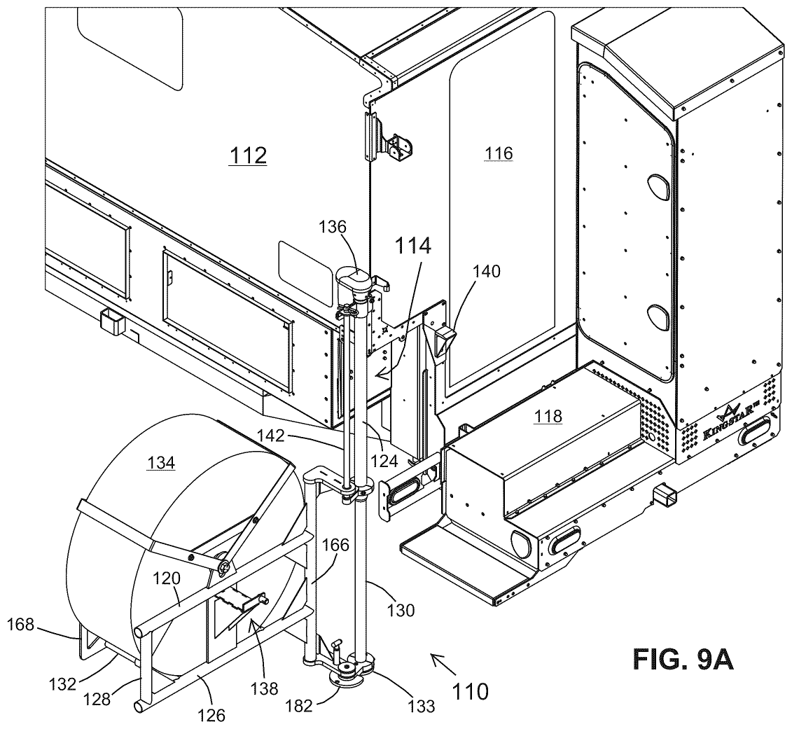

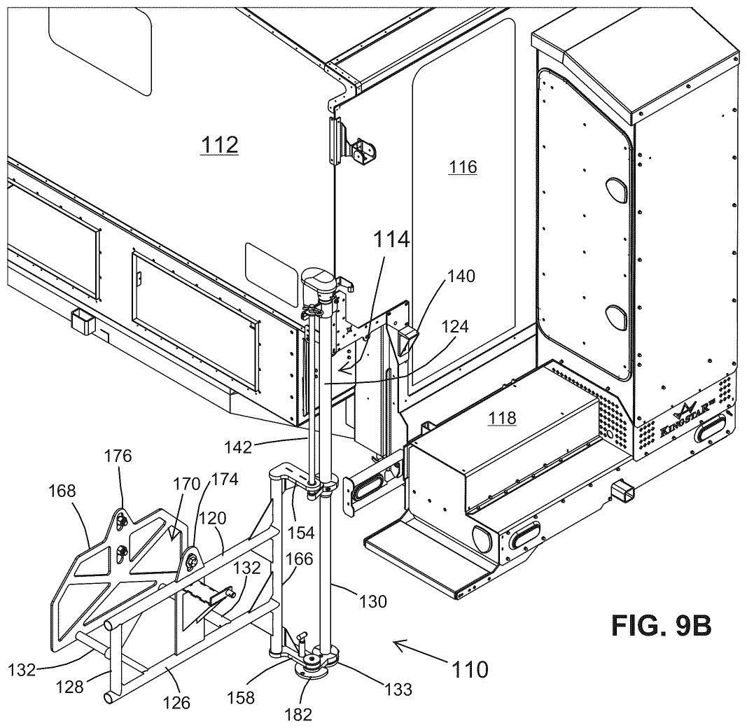

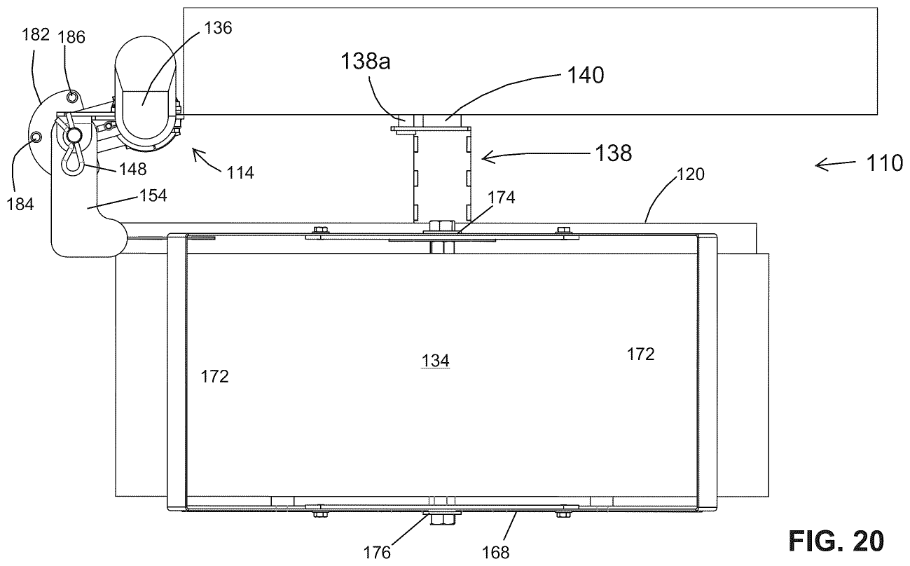

Returning to FIGS. 15-17, coupled to carriage bracket-engaging portion 129a of the lower collar 129 is a lock plate 182 that extends radially outboard of the pivot axis and remains fixed relative to the other portions of lower collar 129 and extendable lower post 130. Lock plate 182 defines a 90-degree lock bore 184 (FIGS. 15, 17, and 20) corresponding to a partially-swung position of the carriage (FIGS. 7A and 7B) and a 180-degree lock bore 186 (FIGS. 16 and 20) corresponding to a fully or further-swung position of the carriage (FIGS. 8A-9B). Lock pin 164 moves circumferentially along lock plate 182 as the carriage is swung between the stowed position of FIGS. 4-5B and 10-13, and the extended position of FIGS. 8A-10 and 14. During such movement when lock pin 164 aligns with one of the lock bores 184, 186 the movement may be paused and the lock pin 164 dropped into the bore 184 or 186 to secure the carriage against further pivoting movement until the lock pin 164 is raised out of the bore 184 or 186 by lifting release handle 164a. In this way, a user may selectively secure the carriage in a desired rotational position for convenient access to the carriage depending on their surroundings and their need for access. It will be appreciated that different or additional bore locations along lock plate 182 would allow for securing the carriage at different rotational positions, and the 90-degree and 180-degree lock bores 184, 186 are merely examples.

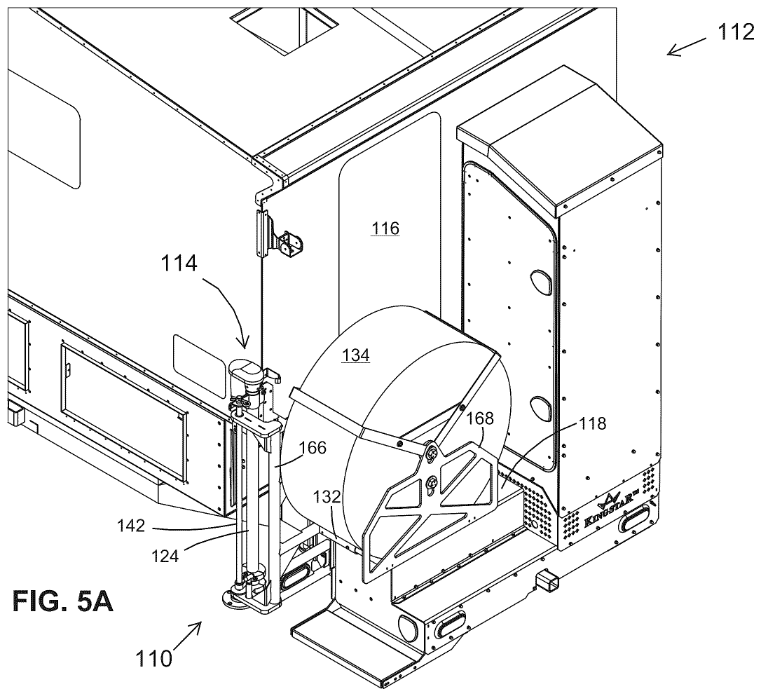

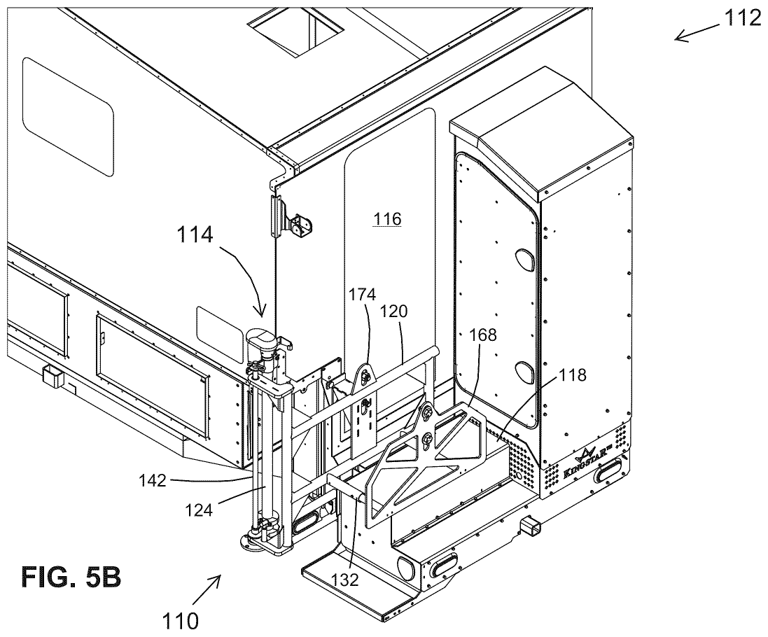

Referring to FIGS. 5B, 6B-10, 14, 19-21, and 23, a retainer projection 138 extends horizontally from between upper later arm 120 and lower lateral arm 160, in an opposite direction of telescoping article supports 132, and is received on a catch 140 that extends rearwardly from truck camper 112 when storage carrier 110 is in the stowed position of FIGS. 4-5B, 11, 12, and 20. Catch 140 has an upper ramped surface that can be engaged by a nose of the retainer projection 138 so that the weight of the carriage and any article(s) 134 will be at least partly supported by the catch 140 when the storage carrier 110 is stowed. A lockable shaft 138a projects from the retainer projection 138 and may be received at a structure associated with catch 140 to provide an optional locking feature, which can also be used to secure the door 116 of the truck camper 112. Tire 134 or other article(s) may also be at least partly supported on a step 118 of the truck camper 112. By relieving the camper jack 114 of some or all of the loads associated with the storage carrier 110 while the storage carrier 110 is stowed, there will be less wear and/or less risk of damage to the camper jack 114, particularly while the vehicle is underway.

Therefore, the storage carriers provide a convenient way to stow, access, and lift articles using the mechanical advantage and/or powered raising capabilities of a camper jack or similar device. The storage carriers may couple directly to an upper or stationary post or tube of the camper jack, or may be indirectly coupled via a support rod. The storage carrier can be readily pivoted between stowed and extended positions, and optionally locked in one or more predetermined extended positions. The camper jack's normal extending and retracting functions, which are not used when the associated truck camper is mounted to a truck, may be put to use for raising and lowering articles using the storage carrier. The storage carrier may be left attached to the camper jack when the camper jack is extended and used to support the truck camper along a ground surface when not mounted to a truck, or the storage carrier may be separated from the camper jack by detaching two or three couplers, brackets, or collars. Thus, the storage carrier may be provided as an aftermarket kit for universal mounting to different camper jacks, or the storage carrier may be customized for attachment to specific camper jacks and optionally offered as combination camper jacks and storage carriers.

Changes and modifications in the specifically described embodiments can be carried out without departing from the principles of the present invention which is intended to be limited only by the scope of the appended claims, as interpreted according to the principles of patent law including the doctrine of equivalents.

1. A storage carrier for coupling to a camper jack, said storage carrier comprising:
an upper arm having a proximal end portion configured for (i) rotatably coupling at an upper post of a camper jack, and (ii) sliding along a longitudinal axis of the camper jack;
a lower arm coupled to said upper arm, said lower arm having a proximal end portion configured for rotatably coupling to an extendable lower post of the camper jack; and
an article support coupled to said upper and lower arms;
wherein said lower arm is configured to raise and lower with the extendable lower post of the camper jack; and
wherein said upper and lower arms are raisable and lowerable together with the extendable lower post of the camper jack, and are pivotable between a stowed position and a deployed position.

2. The storage carrier of claim 1, further comprising an upper slip collar configured for coupling directly to the upper post of the camper jack, wherein said proximal end portion of said upper arm is couplable to the upper post of the camper jack via said upper slip collar, and wherein said upper slip collar is rotatable and longitudinally slidable relative to the upper post of the camper jack.

3. The storage carrier of claim 2, further comprising a lower collar configured for rotatably coupling to the extendable lower post of the camper jack, wherein said proximal end portion of said lower arm is couplable to the extendable lower post of the camper jack via said lower collar.

4. The storage carrier of claim 1, further comprising a support rod configured for coupling to the upper post of the camper jack, wherein said proximal end portion of said upper arm is rotatably coupled directly to said support rod.

5. The storage carrier of claim 4, wherein said support rod is configured to be laterally spaced from the upper post of the camper jack and has a longitudinal axis that is parallel to the longitudinal axis of the camper jack.

6. The storage carrier of claim 5, further comprising a lower bracket configured for coupling directly to the extendable lower post of the camper jack, wherein said lower bracket defines a pivot axis aligned with said longitudinal axis of said support rod.

7. The storage carrier of claim 6, wherein said lower bracket comprises a locking mechanism operable to selectively secure said storage carrier against rotation relative to the camper jack.

8. The storage carrier of claim 7, wherein said locking mechanism comprises a lock plate extending radially outboard of said pivot axis, and a locking pin mounted at said lower arm, wherein said locking pin is actuatable to engage at least one bore formed in said lock plate.

9. The storage carrier of claim 5, further comprising:
an upper coupling bracket for attaching an upper end of said support rod to an upper end of the upper post of the camper jack; and
a lower coupling bracket for attaching a lower end of said support rod to a lower end of the upper post of the camper jack;
wherein said upper and lower coupling brackets are configured to support the respective upper and lower ends of said support rod equidistant from the upper post of the camper jack.

10. The storage carrier of claim 1, wherein said article support comprises at least one chosen from a spare tire rack, a bicycle rack, and a kayak rack.

11. The storage carrier of claim 1, further comprising:
an upright bar coupled between respective distal end portions of said upper and lower arms;
a lateral article support arm coupled to said upright bar;
an article support arm extending perpendicularly from said lateral article support arm; and
an upright article support bracket coupled to and extending upwardly from said article support arms, wherein said tire support bracket is spaced apart from said lateral article support arm to define an article-receiving space therebetween.

12. The storage carrier of claim 11, wherein said article support arm comprises a telescoping arm that is extendable and retractable to change the size of the article-receiving space.

13. The storage carrier of claim 11, further comprising a deployable ramp coupled to said article support arm, wherein said deployable ramp is raisable to enclose a portion of the article-receiving space, and lowerable to facilitate rolling an article between a ground surface and the article-receiving space.

14. The storage carrier of claim 1, further in combination with said camper jack.

15. The storage carrier of claim 14, wherein said camper jack comprises an electric motor that is operable to downwardly extend and upwardly retract said lower post of said camper jack.

16. The storage carrier of claim 1, wherein an article supported at said article support is lowerable into contact with a horizontal step of a vehicle or a truck camper to which the camper jack is attached.

17. The storage carrier of claim 1, wherein an article supported at said article support is lowerable into contact with a ground surface when said upper and lower arms are in the deployed position.

18. The storage carrier of claim 1, further comprising a catch for releasably securing said upper and lower arms in the stowed position.

19. A storage carrier for coupling to a telescoping shaft having a fixed portion and an extendable portion, said storage carrier comprising:
an upper arm configured for both circumferential rotation and longitudinal translation relative to the fixed portion of the telescoping shaft;
a lower arm coupled to said upper arm, said lower arm configured for coupling to the extendable portion of the telescoping shaft, wherein said lower arm is configured to raise and lower with the extendable portion of the telescoping shaft; and
wherein said upper and lower arms are raisable and lowerable together with the extendable portion of the telescoping shaft, and are pivotable relative to the fixed portion of the telescoping shaft between a stowed position and a deployed position.

20. The storage carrier of claim 19, wherein said upper arm is configured for coupling directly to the fixed portion of the telescoping shaft via an upper sliding collar, and said lower arm is configured for coupling directly to the extendable portion of the telescoping shaft via a lower collar.
